(19) United States
(12) Patent Application Publication
(10) Pub. No.: US 2024/0277029 A1
(43) Pub. Date: Aug. 22, 2024

(54) AEROSOL GENERATING COMPOSITIONS

(71) Applicant: Nicoventures Trading Limited, London (GB)

(72) Inventors: John RICHARDSON, London (GB); Sydney TAVERN, London (GB)

(21) Appl. No.: 18/571,293

(22) PCT Filed: Jun. 17, 2022
(86) PCT No.: PCT/GB2022/051545

§ 371 Date: Dec. 18, 2023

(30) Foreign Application Priority Data
Jun. 18, 2021 (GB) 2108830.7

(51) Int. Cl. A24D 1/20; A24B 15/12; A24B 15/30; H05B 6/10

(52) U.S. Cl. CPC A24D 1/20; A24B 15/12; A24B 15/303; H05B 6/106

(57) ABSTRACT

An aerosol-generating composition including an aerosol-generating material and a fibrous susceptor material, as well as a process for making the aerosol-generating composition.

### RELATED APPLICATIONS

The present application is a National Phase entry of PCT Application No. PCT/GB2022/051545 filed Jun. 17, 2022, which claims priority to GB Patent Application No. 2108830.7 filed Jun. 18, 2021, each of which is herby incorporated by reference in their entirety.

### TECHNICAL FIELD

The present application relates to aerosol-generating compositions, components comprising the aerosol-generating compositions and articles for use in non-combustible aerosol-provision systems comprising the components.

### BACKGROUND

Aerosol-generating systems produce an aerosol during use, which is inhaled by a user. For example, tobacco heating devices heat an aerosol-generating material such as tobacco to form an aerosol by heating, but not burning, the aerosol-generating material. Some aerosol-generating systems include a susceptor which is configured to heat the aerosol-generating material and form an aerosol.

### SUMMARY

According to a first aspect of the disclosure, there is provided an aerosol-generating composition comprising an aerosol-generating material and a fibrous susceptor material.

In some embodiments, the fibrous susceptor material is permeable to the passage of gas.

In some embodiments, the fibrous susceptor material is a woven or non-woven material.

In some embodiments, the fibrous susceptor material comprises metal fibers or carbon fibers.

In some embodiments, the fibrous susceptor material is in the form of a sheet or shredded sheet.

In some embodiments, the sheet has a thickness of 150 μm to 300 μm.

In some embodiments, the aerosol-generating material comprises: binder; aerosol-former; optionally an active or flavor; and optionally a filler.

In some embodiments, the aerosol-generating material comprises botanical material.

In some embodiments, the aerosol-generating composition comprises a plurality of strands of aerosol-generating material.

In some embodiments, the article comprises a plurality of strands of the fibrous susceptor material.

In some embodiments, the strands of aerosol-generating are substantially parallel to one another.

In some embodiments, the strands of fibrous susceptor material are substantially parallel to one another.

In some embodiments, the strands of aerosol-generating material and the strands of fibrous susceptor material are substantially parallel to one another.

In some embodiments, each of the strands of aerosol-generating material is substantially straight.

In some embodiments, each of the strands of fibrous susceptor material are substantially straight.

In some embodiments, the strands of fibrous susceptor material have a length of 10 mm to 15 mm.

In some embodiments, the aerosol-generating composition comprises reconstituted tobacco material.

In some embodiments, the fibrous susceptor material comprises fibers that are randomly oriented with respect to each other.

According to a second aspect of the disclosure, there is provided a process for manufacturing the aerosol-generating composition of the first aspect.

In some embodiments, the process comprises combining the aerosol-generating material with the fibrous susceptor material.

In some embodiments, the process comprises: providing a sheet of the aerosol-generating material; providing a sheet of the fibrous susceptor material; cutting the sheet of aerosol-generating material to form a plurality of discrete portions of aerosol-generating material; cutting the sheet of fibrous susceptor material to form a plurality of discrete portions of fibrous susceptor material; and combining the plurality of discrete portions of aerosol-generating material with the plurality of discrete portions of fibrous susceptor material to form the aerosol-generating composition.

In some embodiments, the sheet of aerosol-generating material and the sheet of fibrous susceptor material are cut simultaneously.

An aerosol-generating composition can be manufactured according to the process of the second aspect.

According to a third aspect of the disclosure, there is provided a component for an article for use with a non-combustible aerosol provision device, the component comprising the aerosol-generating composition of the first aspect or manufactured according to the process of the second aspect.

In some embodiments, the component comprises a wrapper circumscribing the aerosol-generating composition.

In some embodiments, the component is in the form of a rod.

In some embodiments, the component is an aerosol-generating section for an article for use with a non-combustible aerosol provision device.

According to a fourth aspect of the disclosure, there is provided a process for manufacturing a component according to the third aspect.

In some embodiments, the process comprises: inserting one or more of a plurality of discrete portions of aerosol-generating material into a wrapper; and inserting one or more of a plurality of discrete portions of fibrous susceptor material into the wrapper to form the component.

In some embodiments, the process comprises: combining an aerosol-generating composition with a fibrous susceptor material field to form a mixture; circumscribing the mixture with a wrapper to form the component.

In some embodiments, the process comprises gathering the strands together to form a rod.

In some embodiments, the process comprises cutting a sheet of aerosol-generating composition longitudinally to produce the plurality of discrete portions of aerosol-generating material and cutting the sheet of fibrous susceptor material longitudinally to produce the plurality of discrete portions of fibrous susceptor material.

A component for an article for use with a non-combustible aerosol provision device can be manufactured according to the process of the fourth aspect.

In some embodiments, the component is an aerosol-generating section of an article for use with a non-combustible aerosol-provision device.

According to a fifth aspect of the disclosure, there is provided an article for us with a non-combustible aerosol-provision device comprising the component of the third aspect.

### BRIEF DESCRIPTION OF THE DRAWINGS

Embodiments of the invention will now be described, by way of example only, with reference to the accompanying drawings, in which:

FIG. 1 is a perspective view of an article for use with a non-combustible aerosol provision device;

FIG. 2 is a side-on cross-sectional view of a part of an article for use with a non-combustible aerosol provision device;

FIG. 3 is an overview of a process for manufacturing a component for use with an article for use with a non-combustible aerosol provision device;

FIG. 4 is a perspective view of a bobbin of aerosol-generating material;

FIG. 4a is a perspective view of a bobbin of fibrous susceptor material;

FIGS. 5 and 6 are schematic diagrams of processes for manufacturing a component for use with an article for use with a non-combustible aerosol provision device;

FIG. 7 is a side-on cross-sectional view of an article for use with a non-combustible aerosol provision device; and

FIGS. 8 to 11 are schematic views of non-combustible aerosol provision devices.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to articles comprising aerosol-generating material and configured to be used with non-combustible aerosol provision devices. These articles are sometimes referred to as consumables throughout the disclosure.

The terms ‘upstream’ and ‘downstream’ used herein are relative terms defined in relation to the direction of mainstream aerosol drawn through an article or device in use.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate, which may be energised so as to distribute power in the form of heat to an aerosol-generating material or to a heat transfer material in proximity to the exothermic power source.

In some embodiments, the non-combustible aerosol provision system comprises an area for receiving the article for use in the non-combustible aerosol-provision system, an aerosol generator, an aerosol generation area, a housing, a mouthpiece, a filter and/or an aerosol-modifying agent.

In some embodiments, the article for use with the non-combustible aerosol provision device comprises an aerosol-generating composition comprising aerosol-generating material, an aerosol-generating composition storage area, an aerosol-generating composition transfer component, an aerosol generator, an aerosol generation area, a housing, a wrapper, a filter, a mouthpiece, and/or an aerosol-modifying agent.

In the figures described herein, like reference numerals are used to illustrate equivalent features, articles or components.

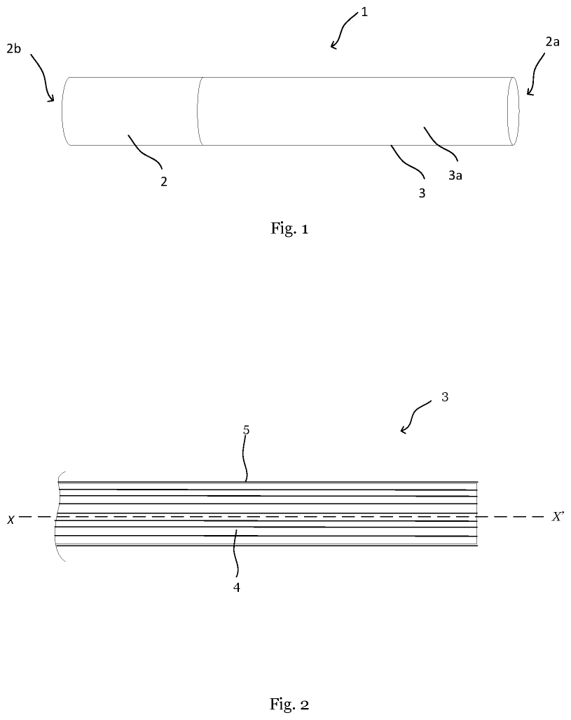

FIG. 1 is a perspective view of an article for use with a non-combustible aerosol-provision device.

The article 1 comprises a mouthpiece 2, and an aerosol-generating section 3, connected to the mouthpiece 2. In the present example, the aerosol generating section 3 comprises an aerosol-generating composition 3a in the form of a cylindrical rod. The article 1 comprises an upstream end 2a and a downstream end 2b distal from upstream end 2a.

The aerosol-generating composition 3a comprises aerosol-generating material and a fibrous susceptor material, which is heatable by using inductive heating.

Inductive heating is a process of heating an electrically conducting object (such as a susceptor) by electromagnetic induction. A magnetic field generator may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The fibrous susceptor material comprises a plurality of fibers formed from a material that is heatable by penetration with a varying magnetic field. Examples of such materials include metals, such as ferrous metals, copper, aluminium, steel and non-metals, such as carbon, carbon fiber, graphite and silicon carbide. The fibers can be made from other materials that are heatable by penetration with

The fibers can be randomly oriented with respect to each other or they can each have the same orientation.

The fibrous susceptor material can be in the form of a woven sheet, a non-woven sheet, or a sintered sheet. The fibrous susceptor material can be a metallic needle-punched felt, which is typically formed by needle punching to entangle the fibers.

Non-woven materials typically comprise sheet or web structures formed by entangling fiber or filaments, or by perforating films. They can be formed mechanically, thermally or chemically. They are generally planar or tufted porous sheets that are made directly from separate fibers or molten materials. Non-woven materials are not made by weaving or knitting and do not require converting the fibers to yarn.

Needle-punched non-woven fabrics can be made from various fibrous webs (for example, carded webs) in which fibers are bonded together mechanically through fiber entanglement and friction after fine needle barbs are repeatedly penetrated through the fibrous web.

The fibrous material may be porous. This makes the fibrous susceptor material particularly well-suited to use in an article for use with a non-combustible aerosol provision device as are and aerosol can pass through the fibrous susceptor material.

The fibrous susceptor material may comprise a mixture of fibers that are heatable by penetration with a varying magnetic field and fibers that are not heatable by penetration with a varying magnetic field. For example, the fibrous susceptor material may comprise metal fibers woven with synthetic or non-synthetic threads, such as cotton, nylon or polyester. The fibrous susceptor material may comprise a mixture of fibers made from different materials heatable by penetration with a varying magnetic field. For example, the fibrous susceptor material may comprise a mixture of metallic fibers and carbon fibers. The presence of fibers made from different materials may enhance the strength and robustness of the fibrous susceptor material.

The fibrous susceptor material may have a relatively large surface area to volume ratio. This may help to improve the contact between the fibrous susceptor material and aerosol-generating material that is in close proximity to the fibrous susceptor material. Thus, heat generated by the fibrous susceptor material in use is efficiently transferred to the surrounding aerosol-generating material. Furthermore, a relatively low mass of the fibrous susceptor material may be required to achieve sufficient heating of the aerosol-generating material in use, owing to its relatively large surface area to volume ratio.

The fibrous susceptor material can be a flexible or rigid sheet material. The fibrous susceptor may be in the form of a continuous sheet or a discontinuous sheet, such as a mesh or web. In some embodiments, the fibrous susceptor comprises a plurality of strands or strips of fibrous susceptor material. Where the fibrous susceptor material is a flexible sheet, it may exhibit sufficient flexibility to be wound onto itself to form a bobbin of fibrous susceptor material. This makes the fibrous susceptor material easy to handle during manufacturing. Furthermore, the fibrous sheet may be easy to cut (e.g. into strands or strips) compared to other types of susceptor material. This makes the fibrous susceptor particularly suited to rapid continuous manufacturing techniques.

Where the fibrous susceptor material is a sheet, the sheet may have a thickness of from about 1 μm to 500 μm. The susceptor material can have a thickness of from about 150 μm to about 300 μm. The sheet of fibrous susceptor material may be shredded to form a shredded sheet of fibrous susceptor material. The shredded sheet may be blended with aerosol-generating material, which may also be in the form of a shredded sheet.

The aerosol-generating composition comprises an aerosol-generating material. The aerosol-generating material may comprise a binder and an aerosol former.

An aerosol-generating material is a material that is capable of generating aerosol, for example when heated, irradiated or energized in any other way. The aerosol-generating material may be in the form of a solid, liquid, or semi-solid, such as a gel and may or may not contain an active substance and/or flavorants.

The aerosol-generating composition comprises at least one aerosol-generating material. The aerosol-generating material may comprise a plurality of aerosol-generating materials. The aerosol-generating materials may be the same as each other or different to each other. For example, the aerosol-generating composition may comprise a first aerosol-generating material and a second aerosol-generating material. Further (for example, third, fourth, fifth or more) aerosol-generating materials may also be included in the composition.

At least one of the aerosol-generating materials may be an aerosol-generating material comprising a binder (which may be a gelling agent) and an aerosol former. Optionally, an active and/or filler may also be present. Optionally, a solvent, such as water, is also present and one or more other components of the aerosol-generating material may or may not be soluble in the solvent.

In some embodiments, the binder comprises or is a gelling agent. The binder may comprise one or more compounds selected from the group comprising alginates, pectins, starches (and derivatives), celluloses (and derivatives), gums, silica or silicones compounds, clays, polyvinyl alcohol and combinations thereof. For example, in some embodiments, the binder comprises one or more of alginates, pectins, hydroxyethyl cellulose, hydroxypropyl cellulose, carboxymethylcellulose, pullulan, xanthan gum, guar gum, carrageenan, agarose, acacia gum, fumed silica, PDMS, sodium silicate, kaolin and polyvinyl alcohol. In some embodiments, the binder comprises a hydrocolloid. In some cases, the binder comprises alginate and/or pectin, and may be combined with a setting agent (such as a calcium source) during formation of the aerosol-generating material. In some cases, the aerosol-generating material may comprise a calcium-crosslinked alginate and/or a calcium-crosslinked pectin.

The binder may comprise one or more compounds selected from cellulosic binders, non-cellulosic binders, guar gum, acacia gum and mixtures thereof.

In some embodiments, the cellulosic binder is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the binder comprises (or is) one or more of hydroxyethyl cellulose, hydroxypropyl cellulose, hydroxypropyl methylcellulose (HPMC), carboxymethylcellulose, guar gum, or acacia gum.

In some embodiments, the binder comprises (or is) one or more non-cellulosic binders, including, but not limited to, agar, xanthan gum, gum Arabic, guar gum, locust bean gum, pectin, carrageenan, starch, alginate, and combinations thereof. In preferred embodiments, the non-cellulose based binder is alginate or agar.

In some examples, the aerosol-generating material comprises a binder in an amount of from about 5 to 40 wt % of the aerosol-generating material, or 15 to 40 wt %. That is, the aerosol-generating material may comprise the binder in an amount of about 5 to 40 wt % by dry weight of the aerosol-generating material, or 15 to 40 wt %. In some examples, the aerosol-generating material comprises the binder in an amount of from about 20 to 40 wt %, or about 15 wt % to 35 wt % of the aerosol-generating material.

In some examples, alginate is comprised in the binder in an amount of from about 5 to 40 wt % of the aerosol-generating material, or 15 to 40 wt %. That is, the aerosol-generating material comprises alginate in an amount of about 5 to 40 wt % by dry weight of the aerosol-generating material, or 15 to 40 wt %. In some examples, the aerosol-generating material comprises alginate in an amount of from about 20 to 40 wt %, or about 15 wt % to 35 wt % of the aerosol-generating material.

In some examples, pectin is comprised in the binder in an amount of from about 3 to 15 wt % of the aerosol-generating material. That is, the aerosol-generating material comprises pectin in an amount of from about 3 to 15 wt % by dry weight of the aerosol-generating material. In some examples, the aerosol-generating material comprises pectin in an amount of from about 5 to 10 wt % of the aerosol-generating material.

In some examples, guar gum is comprised in the binder in an amount of from about 3 to 40 wt % of the aerosol-generating material. That is, the aerosol-generating material comprises guar gum in an amount of from about 3 to 40 wt % by dry weight of the aerosol-generating material. In some examples, the aerosol-generating material comprises guar gum in an amount of from about 5 to 10 wt % of the aerosol-generating material. In some examples, the aerosol-generating material comprises guar gum in an amount of from about 15 to 40 wt % of the aerosol-generating material, or from about 20 to 40 wt %, or from about 15 to 35 wt %.

In examples, the alginate is present in an amount of at least about 50 wt % of the binder. In examples, the aerosol-generating material comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

The aerosol-generating material may be formed by forming a slurry, which is then dried to form a solid. The inclusion of a binder in the slurry results in the aerosol-generating material being formed from a dried gel. It has been found that, by including a binder in the aerosol-generating material, flavorant compounds, for example, menthol, are stabilised within the gel matrix allowing a higher flavorant loading to be achieved than in non-gel compositions. The flavoring (e.g. menthol) is stabilised at high concentrations and the products have a good shelf life.

In some embodiments, the binder comprises alginate, and the binder is present in the aerosol-generating material in an amount of from 10-30 wt %, 20-35 wt % or 25-30 wt % of the slurry/aerosol-generating material (calculated on a dry weight basis). In some embodiments, alginate is the only binder present in the aerosol-generating material. In other embodiments, the binder comprises alginate and at least one further binder, such as pectin.

The aerosol-generating material may comprise an aerosol former. An “aerosol former” (also referred to herein as an aerosol former material) is an agent that promotes the generation of an aerosol. An aerosol former may promote the generation of an aerosol by promoting an initial vaporization and/or the condensation of a gas to an inhalable solid and/or liquid aerosol. In some embodiments, an aerosol former may improve the delivery of flavor from the aerosol generating material. In general, any suitable aerosol former or agents may be included in the aerosol generating material of the invention, including those described herein. Other suitable aerosol formers include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

The aerosol former may be included in the aerosol-generating material in an amount of up to about 80 wt % of the aerosol-generating material, such as from about 0.1 wt %, 0.5 wt %, 1 wt %, 3 wt %, 5 wt %, 7 wt % or 10% to about 80 wt %, 75 wt %, 70 wt %, 65 wt %, 60 wt %, 55 wt %, 50 wt %, 45 wt %, 40 wt %, 35 wt %, 30 wt % or 25 wt % of an aerosol former material. In some embodiments, the aerosol-generating material comprises an aerosol former in an amount of about 40 to 80 wt %, 40 to 75 wt %, 50 to 70 wt %, or 55 to 65 wt %.

In some embodiments, the aerosol former is glycerol, propylene glycol, or a mixture of glycerol and propylene glycol. Glycerol may be present in an amount of from 10 to 20% by weight of the tobacco material, for example 13 to 16% by weight of the composition, or about 14% or 15% by weight of the composition. Propylene glycol, if present, may be present in an amount of from 0.1 to 0.3% by weight of the composition.

The aerosol former material may act as a plasticiser. In some cases, the aerosol former material comprises one or more compound selected from erythritol, propylene glycol, glycerol, triacetin, sorbitol and xylitol. In some cases, the aerosol former material comprises, consists essentially of, or consists of glycerol. It has been established that if the content of the plasticiser is too high, the aerosol-generating material may absorb water resulting in a material that does not create an appropriate consumption experience in use. It has been established that if the plasticiser content is too low, the aerosol-generating material may be brittle and easily broken. The plasticiser content specified herein provides an aerosol-generating material flexibility which allows the sheet to be wound onto a bobbin, which is useful in manufacture of consumables or can allow the sheet to be transported prior to shredding.

The aerosol former may enhance the mouthfeel, as well as the organoleptic properties in general, of the aerosol produced by the aerosol-generating material when heated and inhaled by a user, particularly where the aerosol-generating material comprises relatively high quantities (e.g. >40 wt %) of aerosol former. The capability of aerosol-generating materials to retain high quantities of aerosol former may reduce the need for other components of the aerosol-generating material, such as the expanded botanical material, to be loaded with high quantities of aerosol former. This may improve manufacturing efficiency.

The aerosol-generating material may comprise a filler. The filler is generally a non-tobacco component, that is, a component that does not include ingredients originating from tobacco. The filler component may be a non-tobacco fiber such as wood fiber or pulp or wheat fiber. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent.

In some cases, the aerosol-generating material comprises 5-50 wt %, 10-40 wt % or 15-30 wt % of the filler. In some such cases the aerosol-generating material comprises at least 1 wt % of the filler, for example, at least 5 wt %, at least 10 wt %, at least 20 wt % at least 30 wt %, at least 40 wt %, or at least 50 wt % of a filler. In exemplary embodiments the aerosol-generating material comprises from 5-25 wt % of a filler comprising fibers. Suitably the filler consists of fibers, or is in the form of fibers.

In some embodiments, the aerosol-generating material comprises less than 60 wt % of the filler, such as from 1 wt % to 60 wt %, or 5 wt % to 50 wt %, or 5 wt % to 30 wt %, or 10 wt % to 20 wt %.

In other embodiments, the aerosol-generating material comprises less than 20 wt %, suitably less than 10 wt % or less than 5 wt % of the filler.

The filler may comprise one or more organic filler materials such as wood pulp, cellulose and cellulose derivatives (such as methylcellulose, hydroxypropyl cellulose, and carboxymethyl cellulose (CMC)). An inorganic filler, such as calcium carbonate or chalk may be used. In some embodiments, the aerosol-generating material comprises no calcium carbonate such as chalk.

Suitably, the filler is fibrous. For example, the filler may be a fibrous organic filler material such as wood pulp, hemp fiber, cellulose or cellulose derivatives (such as methylcellulose, hydroxypropyl cellulose, and carboxymethyl cellulose (CMC)). Without wishing to be bound by theory, it is believed that including fibrous filler in an aerosol-generating material may increase the tensile strength of the material. Additionally, including a fibrous filler has been found to improve the handling of the aerosol-generating material during manufacturing. In particular, it has been found that the resulting aerosol-generating material is less “tacky” and consequently is easier to shred during manufacturing. Including a fibrous filler can therefore increase manufacturing efficiency, reducing the likelihood of machine stops during shredding. Including a fibrous filler in the aerosol-generating material also means that the aerosol-generating material is less likely to clump together (e.g. agglomerate) once it has been shredded. When the shredded aerosol-generating material is included in consumables, reduced agglomeration optimises the distribution of the shredded aerosol-generating material in the consumables. It is therefore more likely that each consumable will contain a similar quantity of shredded aerosol-generating material, which may improve homogeneity of the flavorant loading within batches of consumables and/or within a given consumable.

In some embodiments, the aerosol-generating material comprises a substance to be delivered. The substance to be delivered may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives (including, where appropriate but not limited to, the corresponding acid forms of these materials), or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco material.

As used herein, the term “tobacco material” refers to a material derived from a plant of the Nicotiana species. The selection of the plant of the Nicotiana species is not limited, and the types of tobacco or tobaccos used may vary. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, leaf tobacco, tobacco stem, reconstituted tobacco and/or tobacco extract. As used herein, “leaf tobacco” means cut lamina tobacco.

In some embodiments, the tobacco material is selected from flue-cured or Virginia, Burley, sun-cured, Maryland, dark-fired, dark air cured, light air cured, Indian air cured, Red Russian and Rustica tobaccos, and mixtures thereof, as well as various other rare or specialty tobaccos, green or cured. Tobacco material produced via any other type of tobacco treatment which could modify the tobacco taste, such as fermented tobacco or genetic modification or crossbreeding techniques, is also within the scope of the present disclosure. For example, it is envisaged that tobacco plants may be genetically engineered or crossbred to increase or decrease production of components, characteristics or attributes.

In some embodiments, the tobacco material is sun-cured tobacco, selected from Indian Kurnool and Oriental tobaccos, including Izmir, Basma, Samsun, Katerini, Prelip, Komotini, Xanthi and Yambol tobaccos. In some embodiments, the tobacco material is dark air cured tobacco, selected from Passanda, Cubano, Jatin and Besuki tobaccos. In some embodiments, the tobacco material is light air cured tobacco, selected from North Wisconsin and Galpao tobaccos.

In some embodiments, the tobacco material is selected from Brazilian tobaccos, including Mata Fina and Bahia tobaccos. In some embodiments, the tobacco material is selected from criollo, Piloto Cubano, Olor, Green River, Isabela DAC, White Pata, Eluru, Jatim, Madura, Kasturi, Connecticut Seed, Broad Leaf, Connecticut, Pennsylvanian, Italian dry air cured, Paraguayan dry air cured and One Sucker tobaccos.

For the preparation of smoking/vaping or smokeless tobacco products, plants of the Nicotiana species may be subjected to a curing process. Certain types of tobaccos may be subjected to alternative types of curing processes, such as fire curing or sun curing. Preferably, but not necessarily, harvested tobaccos that are cured are aged.

The tobacco can be harvested in different stages of growth, for example when the plant is has reached a level of maturity and the lower leaves are ready for harvest whilst the upper leaves are still in development.

In some embodiments, at least one portion of the plant of the Nicotiana species (e.g., at least a portion of the tobacco material) is employed in an immature form. That is, in some embodiments, the plant, or at least one portion of that plant, is harvested before reaching a stage normally regarded as ripe or mature.

In some embodiments, at least a portion of the plant of the Nicotiana species (e.g. at least a portion of the tobacco material) is employed in a mature form. That is, in some embodiments, the plant, or at least one portion of that plant, is harvested when that plant (or plant portion) reaches a point that is traditionally viewed as being ripe, over-ripe or mature, which can be accomplished through the use of tobacco harvesting techniques conventionally employed by farmers. Both Oriental tobacco and Burley tobacco plants can be harvested. Also, the Virginia tobacco leaves can be harvested or primed depending upon their stalk position.

The Nicotiana species may be selected for the content of various compounds that are present in the plant. For example, plants may be selected on the basis that those plants produce relatively high quantities of one or more of the compounds desired to be isolated (i.e. the volatile compounds of interest). In certain embodiments, plants of the Nicotiana species are specifically cultivated for their abundance of leaf surface compounds. Tobacco plants may be grown in green-houses, growth chambers, or outdoors in fields, or grown hydroponically.

Various parts or portions of the plant of the Nicotiana species may be utilized. In some embodiments, the whole plant, or substantially the whole plant, is harvested and employed as such. As used herein, the term “substantially the whole plant” means that at least 90% of the plant is harvested, such as at least 95% of the plant, such as at least 99% of the plant. Alternatively, in some embodiments, various parts or pieces of the plant are harvested or separated for further use after harvest. In some embodiments, the tobacco material is selected from the leaves, stems, stalks of the plant, and various combinations of these parts. The tobacco material of the disclosure may thus comprise an entire plant or any portion of a plant of the Nicotiana species.

The tobacco material may comprise or consist of reconstituted tobacco, tobacco lamina, paper reconstituted tobacco, extruded tobacco, bandcast reconstituted tobacco, or a combination of reconstituted tobacco and another form of tobacco, such as tobacco lamina or granules.

In some embodiments, the aerosol-generating material is substantially free from botanical material. In particular, in some embodiments, the aerosol-generating material is substantially tobacco free.

In some embodiments, the active substance comprises or is derived from one or more botanicals or constituents, derivatives or extracts thereof and the botanical is selected from eucalyptus, star anise, cocoa and hemp.

In some embodiments, the active substance comprises or is derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor extracts of botanicals, synthetically obtained materials, or materials, botanicals, combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the aerosol-generating material may comprise up to about 80 wt %, 70 wt %, 60 wt %, 55 wt %, 50 wt % or 45 wt % of flavorant. In some cases, the aerosol-generating material may comprise at least about 0.1 wt %, 1 wt %, 10 wt %, 20 wt %, 30 wt %, 35 wt % or 40 wt % of flavorant (all calculated on a dry weight basis). For example, the aerosol-generating material may comprise 1-80 wt %, 10-80 wt %, 20-70 wt %, 30-60 wt %, 35-55 wt % or 30-45 wt % of flavorant. In exemplary embodiments, the aerosol-generating material comprises 35-50 wt % of flavorant. In some cases, the flavorant comprises, consists essentially of or consists of menthol.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-generating composition may comprise an aerosol generating material in the form of an “amorphous solid”. The aerosol-generating material may be a “monolithic solid”. In some embodiments, the aerosol-generating material may be a dried gel.

The aerosol-generating composition may comprise an aerosol generating material in the form of an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating material may comprise or be a sheet, which may optionally be shredded to form a shredded sheet. The sheet of aerosol-generating material may be cut lengthwise and/or width-wise, for example in a cross-cut type shredding process, to define a cut length for the strands or strips of aerosol-generating material, in addition to a cut width.

The aerosol-generating material may be in the form of strands or strips of material. These strands or strips may have a thickness (measured by callipers) of from about 150 μm to about 300 μm, from about 200 μm to about 300 μm or from about 200 μm to about 250 μm. Such thicknesses allow for the aerosol-generating material to be dried efficiently during its manufacture and for the aerosol-generating material to have the required flexibility for processing.

The strands or strips of aerosol-generating material can have a length of from about 10 mm to 15 mm. In some embodiments, the strands or strips of aerosol-generating material can have a length of about 10 mm, 11 mm, 12 mm, 13 mm, 14 mm or 15 mm.

The aerosol-generating composition can comprise strands or strips of aerosol generating material mixed with strands or strips of the fibrous susceptor material. The strands or strips of aerosol-generating material can have a length that is identical to, or within, for example 10 or 20% of, the length of the strands or strips of fibrous susceptor material. Each strand or strip of aerosol-generating material may have a similar thickness to the thickness of each strand or strip of fibrous susceptor material. In some embodiments, the thickness of the aerosol-generating material is the same as (or within 20% or 10% of) the thickness of the fibrous susceptor material. Matching the aerosol-generating material thickness and the fibrous susceptor material thickness in this way may help to improve the ease by which the two materials can be mixed and the homogeneity of the final mixture. It may also mean that the same apparatus (e.g. the same cutting tools) can be used to shred the two materials.

Each strand or strip of aerosol-generating material may have a similar length to the length of each strand or strip of fibrous susceptor material. In some embodiments, the length of the aerosol-generating material is the same as (or within 20% or 10% of) the length of the fibrous susceptor material. Matching the aerosol-generating material length and the fibrous susceptor material length in this way may help to improve the ease by which the two materials can be mixed and the homogeneity of the final mixture. It may also mean that the same apparatus (e.g. the same cutting tools) can be used to shred the two materials. Furthermore, the strands or strips of aerosol-generating material can be aligned with the strands or strips of fibrous susceptor material when incorporated into an aerosol-generating section of an article for use with a non-combustible aerosol provision device. As the lengths of the two materials will be the same or similar, the strands or strips of aerosol-generating material may be heated evenly along their length by the strands or strips of fibrous susceptor material.

The aerosol-generating composition may comprise any combination of the above aerosol-generating materials. For example, the aerosol-generating composition may comprise a blend of aerosol-generating materials, at least one of which comprises a binder and an aerosol-former. In some embodiments, the aerosol-generating composition comprises (e.g. a first) aerosol-generating material comprising a binder and an aerosol former and (e.g. a second) different aerosol-generating material. For example, the second aerosol-generating material may be a botanical material, such as tobacco lamina.

In some embodiments, the aerosol-generating material is prepared by forming a slurry comprising components of the aerosol-generating material or precursors thereof, forming a layer of the slurry, setting the slurry to form a gel and drying to form the aerosol-generating material. Optionally, the setting the slurry at step comprises applying a setting agent to the slurry. In some embodiments, a setting agent is sprayed on the slurry, such as a top surface of the slurry.

In some embodiments, the setting agent comprises or consists of calcium acetate, calcium formate, calcium carbonate, calcium hydrogencarbonate, calcium chloride, calcium lactate, or a combination thereof. In some embodiments, the setting agent comprises or consists of calcium formate and/or calcium lactate. In particular embodiments, the setting agent comprises or consists of calcium formate. It has been identified that, typically, employing calcium formate as a setting agent results in an aerosol-generating material having a greater tensile strength and greater resistance to elongation.

The total amount of the setting agent, such as a calcium source, may be 0.5-5 wt % (calculated on a dry weight basis). Suitably, the total amount may be from about 1 wt %, 2.5 wt % or 4 wt % to about 4.8 wt % or 4.5 wt %. It has been found that the addition of too little setting agent may result in an aerosol-generating material which does not stabilise the aerosol-generating material components and results in these components dropping out of the aerosol-generating material. It has been found that the addition of too much setting agent results in an aerosol-generating material that is very tacky and consequently has poor handleability.

When the aerosol-generating material does not contain tobacco, a higher amount of setting agent may need to be applied. In some cases the total amount of setting agent may therefore be from 0.5-12 wt % such as 5-10 wt %, calculated on a dry weight basis. Suitably, the total amount may be from about 5 wt %, 6 wt % or 7 wt % to about 12 wt % or 10 wt %. In this case the aerosol-generating material will not generally contain any tobacco.

The process comprises forming a layer of the slurry. This typically comprises spraying, casting or extruding the slurry. In examples, the slurry layer is formed by electrospraying the slurry. In examples, the slurry layer is formed by casting the slurry.

In some examples, all of the steps of the process, at least partially, occur simultaneously (for example, during electrospraying). In some examples, the steps of the process occur sequentially.

The aerosol-generating material may comprise 1 to 60 wt % of a gelling agent, 0.1 to 70 wt % of an aerosol former material, 5 to 50% of filler in the form of fibers, and 0.1 to 80 wt % of a flavorant and/or active substance.

The aerosol-generating material may comprise 10 to 40 wt % gelling agent, 10 to 70 wt % of an aerosol former material, 20 to 40 wt % of filler and optionally 10 to 50 wt % of a flavorant.

In an embodiment, the aerosol-generating material comprises alginate in an amount of 32.8 w %, glycerol in an amount of 19.2 wt % and menthol in an amount of 48 wt %.

In an embodiment, the aerosol-generating material comprises alginate in amount of 26.2 wt %, glycerol in an amount of 15.4 wt %, menthol in an amount of 38.4 wt % and fibers (from wood pulp) in an amount of 20 wt %.

In an embodiment, the aerosol-generating material comprises alginate in an amount of 32 wt %, pectin in an amount of 8 wt % and glycerol in an amount of 60 wt %.

In an embodiment, the aerosol-generating material comprises alginate in an amount of 24 wt %, pectin in an amount of 6 wt %, cellulose fibers in an amount of 10 wt % and glycerol in an amount of 60 wt %.

In an embodiment, the aerosol-generating material comprises carboxymethyl cellulose (CMC) in an amount of about 7 wt %, cellulose fibers (from wood pulp) in an amount of about 43 wt % and glycerol in an amount of about 50 wt %.

The aerosol-generating composition comprises aerosol-generating material and a fibrous susceptor material. The composition may comprise an intimate mixture of aerosol-generating material and the fibrous susceptor material. The aerosol-generating composition and the fibrous susceptor material may be in direct contact with each other. This may facilitate rapid heat transfer from the fibrous susceptor material to the aerosol-generating composition when a varying magnetic field is applied and the fibrous susceptor material heats up.

FIG. 2 is a side-on cross-sectional view of part of the aerosol-generating section 3 of the article 1. The aerosol-generating section 3 comprises an aerosol-generating component composition 4. The aerosol-generating composition 4 is bounded by a wrapper 5. The aerosol-generating composition comprises a plurality of strands of aerosol-generating material and a plurality of strands of fibrous susceptor material. The strands of aerosol-generating material and fibrous susceptor material are positioned such that their longitudinal axes are in parallel alignment with each other and also the longitudinal axis of the aerosol-generating section 3, X-X′. This may facilitate air flow through the aerosol-generating section in use.

In alternative embodiments, the aerosol-generating material and the fibrous susceptor material can be randomly oriented with respect to each other. In some embodiments, the strands or aerosol-generating material and fibrous susceptor material are crimped or coiled.

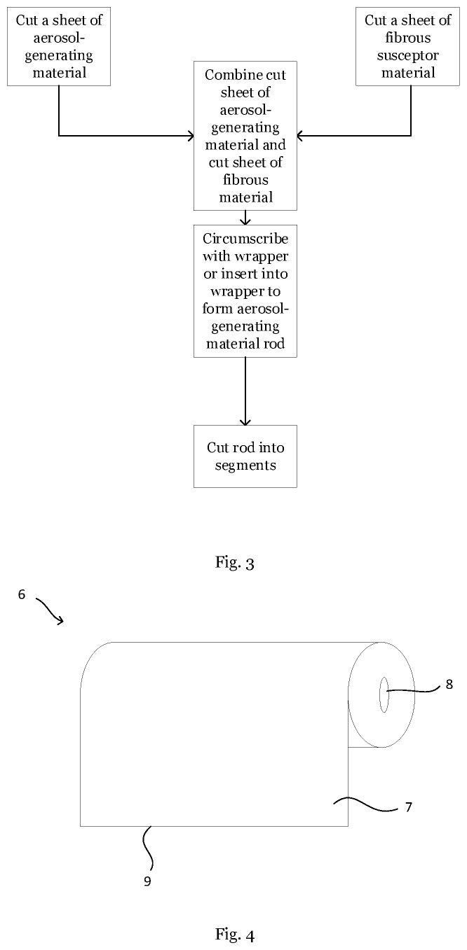

FIG. 3 is an overview of a process that may be used to manufacture the aerosol-generating section 3. The process may comprise cutting a sheet of aerosol-generating material and cutting a sheet of fibrous susceptor material. This forms a plurality of discrete portions of aerosol-generating material and a plurality of discrete portions of fibrous susceptor material. The discrete portions of aerosol-generating material and discrete portions of fibrous susceptor material can be strands or strips. The discrete portions of aerosol-generating material and fibrous susceptor material are then combined to form a mixture. The aerosol-generating material and fibrous susceptor material can be mixed by any suitable means. For example, the two materials can be blended in a mixer. The mixture may then be circumscribed with a wrapper to form a rod, which is then cut into segments to form the aerosol-generating section 3.

Alternatively, the discrete portions of aerosol-generating material and fibrous susceptor material can be inserted into wrapper to form the rod, which is then cut into segments to form the aerosol-generating section 3.

Prior to being cut, the aerosol-generating and/or the fibrous susceptor material may be provided in the form of a wound bobbin.

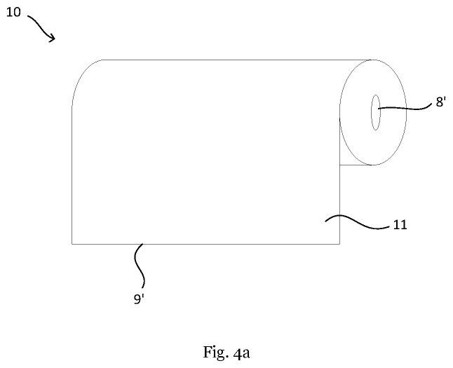

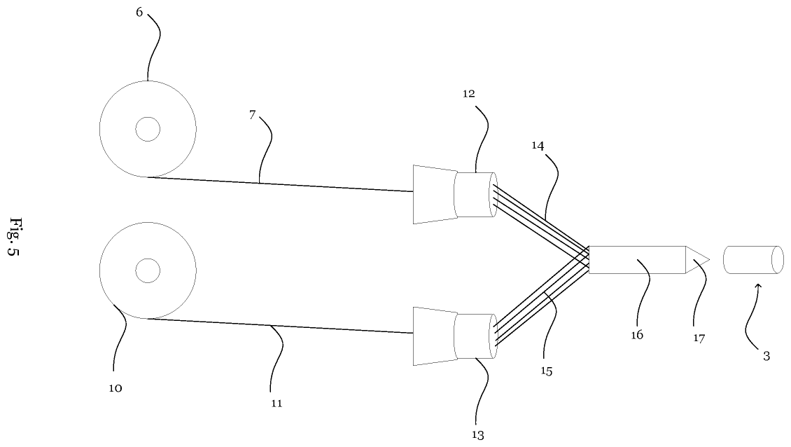

FIG. 4 is a perspective view of a bobbin 6 comprising a sheet of fibrous susceptor material 7 wound around a central spindle 8. As the fibrous material 7 is flexible, it can be readily wound onto itself without damaging it. The fibrous material 7 of the bobbin 6 has a free end 9 which allows the bobbin to be unwound. A similar bobbin comprising a sheet of aerosol-generating material (instead of the fibrous material) may also be provided. The free end 9 may be fed into machinery that continuously cuts the sheet.

FIG. 4a is a perspective view of a bobbin 10 comprising a sheet of aerosol-generating material 11 wound around a central spindle 8′. As the aerosol-generating material 7 is flexible and has sufficient tensile strength, it can be readily wound onto itself without damaging it. The sheet of aerosol-generating material 11 of the bobbin 10 has a free end 9′ which allows the bobbin to be unwound. A similar bobbin comprising a sheet of aerosol-generating material may also be provided. The free end 9′ may be fed into machinery that continuously cuts the sheet.

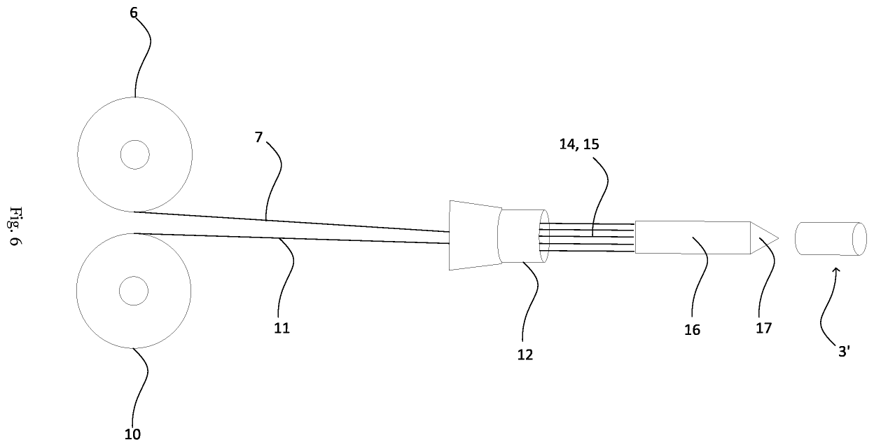

FIG. 5 is a schematic view of a process for manufacturing an aerosol-generating section 3. A bobbin 6 comprising a sheet 7 of fibrous susceptor material is provided and a separate bobbin 10 comprising a sheet 11 of aerosol-generating material is provided. The sheet of fibrous susceptor material 7 is fed into a cutter 12, whilst the sheet of aerosol-generating material 11 is fed into a cutter 13. The cutter 12 cuts the fibrous susceptor material 7 into a plurality of strands 14 of fibrous susceptor material. Meanwhile, the cutter 13 cuts the sheet 11 of aerosol-generating material into a plurality of stands 15 of aerosol-generating material. The plurality of strands 15 of aerosol-generating material and the plurality of strands 14 of fibrous susceptor material are combined and circumscribed by a wrapper to form a rod 16. A cutter 17 cuts the rod to form the aerosol-generating section 3.

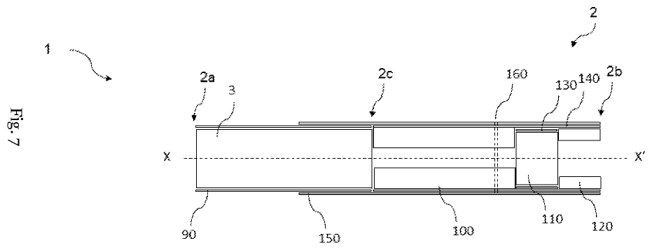

FIG. 6 is a schematic view of an alternative process for manufacturing an aerosol-generating section 3′. A bobbin 6 comprising a sheet of fibrous susceptor material 7 is provided and a separate bobbin 10 comprising a sheet 11 of aerosol-generating material is provided. The sheet 11 of aerosol-generating material and the sheet 7 of fibrous susceptor material are fed into a cutter 12. The cutter 12 cuts both the aerosol-generating sheet 11 into a plurality of strands 14 of aerosol-generating material and the sheet 7 fibrous susceptor material into a plurality of stands 15 of fibrous susceptor material. The cutter simultaneously cuts both the sheet 11 of aerosol-generating material and the sheet 7 of fibrous susceptor material, thereby improving manufacturing efficiency. The plurality of strands 14 of aerosol-generating material and the plurality of strands 15 of fibrous susceptor material are combined and circumscribed by a wrapper to form a rod 16. A cutter 17 cuts the rod to form the aerosol-generating section 3′.

In some embodiments, the process can be configured to control the relative quantities and distribution of fibrous susceptor material and aerosol-generating material in the aerosol-generating section 3, 3′. For example, in the embodiment illustrated in FIG. 5, the rate of cutting the fibrous susceptor material can be lower than the rate of cutting the sheet of aerosol-generating material to provide an aerosol-generating section comprising less fibrous susceptor material. The distribution of fibrous susceptor material in the aerosol-generating section may be controlled by controlling the moment at which the fibrous susceptor material is combined with the aerosol-generating material.

The components formed according to these processes may be used to form an article for use with a non-combustible aerosol provision device.

FIG. 7 shows a side-on cross-sectional view of the article 1 shown in FIG. 1. The article 1 comprises a mouthpiece 2, and an aerosol-generating section 3, connected to the mouthpiece 2. In the present example, the aerosol generating 3 section comprises an aerosol-generating section 3, also referred to as rod of aerosol-generating material 3, comprising an aerosol-generating composition comprising aerosol-generating material and a fibrous susceptor material as described herein. The article 1 comprises an upstream end 2a and a downstream end 2b distal from the aerosol-generating section 3.

In the present example, the aerosol-generating composition comprises a plurality of strands and/or strips of aerosol-generating material 3, and is circumscribed by a wrapper 90. In the present example, the wrapper 90 is a moisture impermeable wrapper.

The plurality of strands or strips of aerosol-generating material may be aligned within the aerosol-generating section such that their longitudinal dimension is in parallel alignment with a longitudinal axis, X-X′ of the article 1. Alternatively, the strands or strips may generally be arranged such that their longitudinal dimension aligned is transverse to the longitudinal axis of the article.

At least about 10%, 20%, 30%, 40%, 50%, 60%, 70%, 80%, 90% or 95% of the plurality of strands or strips may be arranged such that their longitudinal dimension is in parallel alignment with the longitudinal axis of the article. A majority of the strands or strips may be arranged such that their longitudinal dimensions are in parallel alignment with the longitudinal axis of the article. In some embodiments, about 95% to about 100% of the plurality of strands or strips are arranged such that their longitudinal dimension is in parallel alignment with the longitudinal axis of the article. In some embodiments, substantially all of the strands or strips are arranged in the aerosol-generating section such that their longitudinal dimension is in parallel alignment with the longitudinal axis of the aerosol-generating section of the article.

The mouthpiece 2 includes a cooling section 100, also referred to as a cooling element, positioned immediately downstream of and adjacent to the source of aerosol-generating composition 3. In the present example, the cooling section 100 is in an abutting relationship with the source of aerosol-generating material. The mouthpiece 2 also includes, in the present example, a body of material 110 downstream of the cooling section 100 and a hollow tubular element 120 downstream of the body of material 110, at the mouth end of the article 1.

The cooling section 100 comprises a hollow channel, having an internal diameter of between about 1 mm and about 4 mm, for example between about 2 mm and about 4 mm. In the present example, the hollow channel has an internal diameter of about 3 mm. The hollow channel extends along the full length of the cooling section 100. In the present example, the cooling section 100 comprises a single hollow channel. In alternative embodiments, the cooling section can comprise multiple channels, for example, 2, 3 or 4 channels. In the present example, the single hollow channel is substantially cylindrical, although in alternative embodiments, other channel geometries/cross-sections may be used. The hollow channel can provide a space into which aerosol drawn into the cooling section 100 can expand and cool down. In all embodiments, the cooling section is configured to limit the cross-sectional area of the hollow channel/s, to limit tobacco displacement into the cooling section, in use.

The cooling section 100 preferably has a wall thickness in a radial direction, which can be measured, for example, using a calliper. The wall thickness of the cooling section 100 for a given outer diameter of cooling section, defines the internal diameter for the cavity surrounded by the walls of the cooling section 100. The cooling section 100 can have a wall thickness of at least about 1.5 mm and up to about 2 mm. In the present example, the cooling section 100 has a wall thickness of about 2 mm. The inventors have advantageously found that providing a cooling section 100 having a wall thickness within this range improves the retention of the source of aerosol-generating material in the aerosol generating section, in use, by reducing the longitudinal displacement of strands and/or strips of aerosol-generating material when the aerosol generator is inserted into the article.

The cooling section 100 is formed from filamentary tow. Other constructions can be used, such as a plurality of layers of paper which are parallel wound, with butted seams, to form the cooling section 10; or spirally wound layers of paper, cardboard tubes, tubes formed using a papier-mâché type process, moulded or extruded plastic tubes or similar. The cooling section 100 is manufactured to have a rigidity that is sufficient to withstand the axial compressive forces and bending moments that might arise during manufacture and whilst the article 1 is in use.

The wall material of the cooling section 100 can be relatively non-porous, such that at least 90% of the aerosol generated by the aerosol generating material 3 passes longitudinally through the one or more hollow channels rather than through the wall material of the cooling section 100. For instance, at least 92% or at least 95% of the aerosol generated by the aerosol generating material 3 can pass longitudinally through the one or more hollow channels.

The filamentary tow forming the cooling section 100 preferably has a total denier of less than 45,000, more preferably less than 42,000. This total denier has been found to allow the formation of a cooling section 100 which is not too dense. Preferably, the total denier is at least 20,000, more preferably at least 25,000. In preferred embodiments, the filamentary tow forming the cooling section 100 has a total denier between 25,000 and 45,000, more preferably between 35,000 and 45,000. Preferably the cross-sectional shape of the filaments of tow are ‘Y’ shaped, although in other embodiments other shapes such as ‘X’ shaped filaments can be used.

The filamentary tow forming the cooling section 100 preferably has a denier per filament of greater than 3. This denier per filament has been found to allow the formation of a tubular element 120 which is not too dense. Preferably, the denier per filament is at least 4, more preferably at least 5. In preferred embodiments, the filamentary tow forming the hollow tubular element 120 has a denier per filament between 4 and 10, more preferably between 4 and 9. In one example, the filamentary tow forming the cooling section 100 has an Y40,000 tow formed from cellulose acetate and comprising 18% plasticiser, for instance triacetin.

Preferably, the density of the material forming the cooling section 100 is at least about 0.20 grams per cubic centimetre (g/cc), more preferably at least about 0.25 g/cc. Preferably, the density of the material forming the cooling section 100 is less than about 0.80 grams per cubic centimetre (g/cc), more preferably less than 0.6 g/cc. In some embodiments, the density of the material forming the cooling section 100 is between 0.20 and 0.8 g/cc, more preferably between 0.3 and 0.6 g/cc, or between 0.4 g/cc and 0.6 g/cc or about 0.5 g/cc. These densities have been found to provide a good balance between improved firmness afforded by denser material and minimising the overall weight of the article. For the purposes of the present invention, the “density” of the material forming the cooling section 100 refers to the density of any filamentary tow forming the element with any plasticiser incorporated. The density may be determined by dividing the total weight of the material forming the cooling section 100 by the total volume of the material forming the cooling section 100 wherein the total volume can be calculated using appropriate measurements of the material forming the cooling section 100 taken, for example, using callipers. Where necessary, the appropriate dimensions may be measured using a microscope.

Preferably, the length of the cooling section 100 is less than about 30 mm. More preferably, the length of the cooling section 100 is less than about 25 mm. Still more preferably, the length of the cooling section 100 is less than about 20 mm. In addition, or as an alternative, the length of the cooling section 100 is preferably at least about 10 mm. Preferably, the length of the cooling section 100 is at least about 15 mm. In some preferred embodiments, the length of the cooling section 100 is from about 15 mm to about 20 mm, more preferably from about 16 mm to about 19 mm. In the present example, the length of the cooling section 100 is 19 mm.

The cooling section 100 is located around and defines an air gap within the mouthpiece 2 which acts as a cooling section. The air gap provides a chamber through which heated volatilized components generated by the rod of aerosol-generating material 3 flow. The cooling section 100 is hollow to provide a chamber for aerosol accumulation yet rigid enough to withstand axial compressive forces and bending moments that might arise during manufacture and whilst the article 1 is in use. The cooling section 100 provides a physical displacement between the aerosol-generating material 3 and the body of material 110. The physical displacement provided by the cooling section 100 can provide a thermal gradient across the of the length cooling section 100.

Preferably, the mouthpiece 2 comprises a cavity having an internal volume greater than 110 mm³. Providing a cavity of at least this volume has been found to enable the formation of an improved aerosol. More preferably, the mouthpiece 2 comprises a cavity, for instance formed within the cooling section 100 having an internal volume greater than 110 mm³, and still more preferably greater than 130 mm³, allowing further improvement of the aerosol. In some examples, the internal cavity comprises a volume of between about 130 mm³ and about 230 mm³, for instance about 134 mm³ or 227 mm³.

The cooling section 100 can be configured to provide a temperature differential of at least 40 degrees Celsius between a heated volatilized component entering a first, upstream end of the cooling section 100 and a heated volatilized component exiting a second, downstream end of the cooling section 100. The cooling section 100 is preferably configured to provide a temperature differential of at least 60 degrees Celsius, preferably at least 80 degrees Celsius and more preferably at least 100 degrees Celsius between a heated volatilized component entering a first, upstream end of the cooling section 100 and a heated volatilized component exiting a second, downstream end of the cooling section 100. This temperature differential across the length of the cooling section 100 protects the temperature sensitive body of material 110 from the high temperatures of the aerosol-generating material 3 when it is heated.

When in use, the aerosol-generating section may exhibit a pressure drop of from about 15 to about 40 mm H₂O. In some embodiments, the aerosol-generating section exhibits a pressure drop across the aerosol-generating section of from about 15 to about 30 mm H₂O.

The aerosol-generating material may have a packing density of between about 400 mg/cm³ and about 900 mg/cm³ within the aerosol-generating section. A packing density higher than this may increase the pressure drop.

At least about 70% of a volume of the aerosol-generating section is filled with the aerosol-generating material. In some embodiments, from about 75% to about 85% of the volume of the cavity is filled with the aerosol-generating material.

In the present embodiment, the moisture impermeable wrapper 90 which circumscribes the rod of aerosol-generating material comprises aluminium foil. In other embodiments, the wrapper 90 comprises a paper wrapper, optionally comprising a barrier coating to make the material of the wrapper substantially moisture impermeable. Aluminium foil has been found to be particularly effective at enhancing the formation of aerosol within the aerosol-generating material 3. In the present example, the aluminium foil has a metal layer having a thickness of about 6 μm. In the present example, the aluminium foil has a paper backing. However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used. The total thickness of the wrapper is preferably between 20 μm and 60 μm, more preferably between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force. Where the wrapper comprises paper or a paper backing, i.e. a cellulose based material, the wrapper can have a basis weight greater than about 30 gsm. For example, the wrapper can have a basis weight in the range from about 40 gsm to about 70 gsm. Such basis weights provide an improved rigidity to the rod of aerosol-generating material. The improved rigidity provided by wrappers having a basis weight in this range can make the rod of aerosol-generating material 3 more resistant to crumpling or other deformation under the forces to which the article is subject, in use. Providing a rod of aerosol-generating material having increased rigidity can be beneficial where the plurality of strands or strips of aerosol-generating material are aligned within the aerosol-generating section such that their longitudinal dimension is in parallel alignment with the longitudinal axis, since longitudinally aligned strands or strips of aerosol-generating material may provide less rigidity to the rod of aerosol generating material than when the strands or strips are not aligned. The improved rigidity of the rod of aerosol-generating material allows the article to withstand the increased forces to which the article is subject, in use.

In the present example, the moisture impermeable wrapper 90 is also substantially impermeable to air. In alternative embodiments, the wrapper 90 preferably has a permeability of less than 100 Coresta Units, more preferably less than 60 Coresta Units. It has been found that low permeability wrappers, for instance having a permeability of less than 100 Coresta Units, more preferably less than 60 Coresta Units, result in an improvement in the aerosol formation in the aerosol-generating material 3. Without wishing to be bound by theory, it is hypothesized that this is due to reduced loss of aerosol compounds through the wrapper 90. The permeability of the wrapper 90 can be measured in accordance with ISO 2965:2009 concerning the determination of air permeability for materials used as cigarette papers, filter and filter plug wrap joining paper.

The body of material 110 and hollow tubular element 120 each define a substantially cylindrical overall outer shape and share a common longitudinal axis. The body of material 110 is wrapped in a first plug wrap 130. Preferably, the first plug wrap 130 has a basis weight of less than 50 gsm, more preferably between about 20 gsm and 40 gsm. Preferably, the first plug wrap 130 has a thickness of between 30 μm and 60 μm, more preferably between 35 μm and 45 μm. Preferably, the first plug wrap 130 is a non-porous plug wrap, for instance having a permeability of less than 100 Coresta units, for instance less than 50 Coresta units. However, in other embodiments, the first plug wrap 130 can be a porous plug wrap, for instance having a permeability of greater than 200 Coresta Units.

Preferably, the length of the body of material 110 is less than about 15 mm. More preferably, the length of the body of material 110 is less than about 12 mm. In addition, or as an alternative, the length of the body of material 110 is at least about 5 mm. Preferably, the length of the body of material 110 is at least about 8 mm. In some preferred embodiments, the length of the body of material 110 is from about 5 mm to about 15 mm, more preferably from about 6 mm to about 12 mm, even more preferably from about 6 mm to about 12 mm, most preferably about 6 mm, 7 mm, 8 mm, 9 mm or 10 mm. In the present example, the length of the body of material 110 is 10 mm.

In the present example, the body of material 110 is formed from filamentary tow. In the present example, the tow used in the body of material 110 has a denier per filament (d.p.f.) of 5 and a total denier of 25,000. In the present example, the tow comprises plasticised cellulose acetate tow. The plasticiser used in the tow comprises about 9% by weight of the tow. In the present example, the plasticiser is triacetin. In other examples, different materials can be used to form the body of material 110. For instance, rather than tow, the body 1100 can be formed from paper, for instance in a similar way to paper filters known for use in cigarettes. For instance, the paper, or other cellulose-based material, can be provided as one or more portions of sheet material which is folded and/or crimped to form body 110. The sheet material can have a basis weight of from 15 gsm to 60 gsm, for instance between 20 and 50 gsm. The sheet material can, for instance, have a basis weight in any of the ranges between 15 and 25 gsm, between 25 and 30 gsm, between 30 and 40 gsm, between 40 and 45 gsm and between 45 and 50 gsm. Additionally or alternatively, the sheet material can have a width of between 50 mm and 200 mm, for instance between 60 mm and 150 mm, or between 80 mm and 150 mm. For instance, the sheet material can have a basis weight of between 20 and 50 gsm and a width between 80 mm and 150 mm. This can, for instance, enable the cellulose-based bodies to have appropriate pressure drops for an article having dimensions as described herein.

Alternatively, the body 110 can be formed from tows other than cellulose acetate, for instance polylactic acid (PLA), other materials described herein for filamentary tow or similar materials. The tow is preferably formed from cellulose acetate. The tow, whether formed from cellulose acetate or other materials, preferably has a d.p.f. of at least 5. Preferably, to achieve a sufficiently uniform body of material 110, the tow has a denier per filament of no more than 12 d.p.f., preferably no more than 11 d.p.f. and still more preferably no more than 10 d.p.f.

The total denier of the tow forming the body of material 110 is preferably at most 30,000, more preferably at most 28,000 and still more preferably at most 25,000. These values of total denier provide a tow which takes up a reduced proportion of the cross sectional area of the mouthpiece 2 which results in a lower pressure drop across the mouthpiece 2 than tows having higher total denier values. For appropriate firmness of the body of material 110, the tow preferably has a total denier of at least 8,000 and more preferably at least 10,000. Preferably, the denier per filament is between 5 and 12 while the total denier is between 10,000 and 25,000. Preferably the cross-sectional shape of the filaments of tow are ‘Y’ shaped, although in other embodiments other shapes such as ‘X’ shaped filaments can be used, with the same d.p.f. and total denier values as provided herein.

Irrespective of the material used to form the body 110, the pressure drop across body 110, can, for instance, be between 0.3 and 5 mmWG per mm of length of the body 110, for instance between 0.5 mmWG and 2 mmWG per mm of length of the body 110. The pressure drop can, for instance, be between 0.5 and 1 mmWG/mm of length, between 1 and 1.5 mmWG/mm of length or between 1.5 and 2 mmWG/mm of length. The total pressure drop across body 110 can, for instance, be between 3 mmWG and 8 mWG, or between 4 mmWG and 7 mmWG. The total pressure drop across body 110 can be about 5, 6 or 7 mmWG.

As shown in FIG. 7, the mouthpiece 2 of the article 1 comprises an upstream end 2c adjacent to the rod of aerosol-generating material 3 and a downstream end 2b distal from the rod of aerosol-generating material 3. At the downstream end 2b, the mouthpiece 2 has a hollow tubular element 120 formed from filamentary tow. This has advantageously been found to significantly reduce the temperature of the outer surface of the mouthpiece 2 at the downstream end 2b of the mouthpiece which comes into contact with a consumer's mouth when the article 1 is in use. In addition, the use of the tubular element 120 has also been found to significantly reduce the temperature of the outer surface of the mouthpiece 2 even upstream of the tubular element 120. Without wishing to be bound by theory, it is hypothesized that this is due to the tubular element 120 channelling aerosol closer to the centre of the mouthpiece 2, and therefore reducing the transfer of heat from the aerosol to the outer surface of the mouthpiece 2.

The “wall thickness” of the hollow tubular element 120 corresponds to the thickness of the wall of the tube 10 in a radial direction. This may be measured, for example, using a calliper. The wall thickness is advantageously greater than 0.9 mm, and more preferably 1.0 mm or greater. Preferably, the wall thickness is substantially constant around the entire wall of the hollow tubular element 120. However, where the wall thickness is not substantially constant, the wall thickness is preferably greater than 0.9 mm at any point around the hollow tubular element 120, more preferably 1.0 mm or greater. In the present example, the wall thickness of the hollow tubular element 120 is about 1.3 mm.

Preferably, the length of the hollow tubular element 120 is less than about 20 mm. More preferably, the length of the hollow tubular element 120 is less than about 15 mm. Still more preferably, the length of the hollow tubular element 120 is less than about 10 mm. In addition, or as an alternative, the length of the hollow tubular element 120 is at least about 5 mm. Preferably, the length of the hollow tubular element 120 is at least about 6 mm. In some preferred embodiments, the length of the hollow tubular element 120 is from about 5 mm to about 20 mm, more preferably from about 6 mm to about 10 mm, even more preferably from about 6 mm to about 8 mm, most preferably about 6 mm, 7 mm or about 8 mm. In the present example, the length of the hollow tubular element 120 is 7 mm.

Preferably, the density of the hollow tubular element 120 is at least about 0.25 grams per cubic centimetre (g/cc), more preferably at least about 0.3 g/cc. Preferably, the density of the hollow tubular element 120 is less than about 0.75 grams per cubic centimetre (g/cc), more preferably less than 0.6 g/cc. In some embodiments, the density of the hollow tubular element 120 is between 0.25 and 0.75 g/cc, more preferably between 0.3 and 0.6 g/cc, and more preferably between 0.4 g/cc and 0.6 g/cc or about 0.5 g/cc. These densities have been found to provide a good balance between improved firmness afforded by denser material and the lower heat transfer properties of lower density material. For the purposes of the present invention, the “density” of the hollow tubular element 120 refers to the density of the filamentary tow forming the element with any plasticiser incorporated. The density may be determined by dividing the total weight of the hollow tubular element 120 by the total volume of the hollow tubular element 120, wherein the total volume can be calculated using appropriate measurements of the hollow tubular element 120 taken, for example, using callipers. Where necessary, the appropriate dimensions may be measured using a microscope.

The filamentary tow forming the hollow tubular element 120 preferably has a total denier of less than 45,000, more preferably less than 42,000. This total denier has been found to allow the formation of a tubular element 120 which is not too dense. Preferably, the total denier is at least 20,000, more preferably at least 25,000. In preferred embodiments, the filamentary tow forming the hollow tubular element 120 has a total denier between 25,000 and 45,000, more preferably between 35,000 and 45,000. Preferably the cross-sectional shape of the filaments of tow are ‘Y’ shaped, although in other embodiments other shapes such as ‘X’ shaped filaments can be used.

The filamentary tow forming the hollow tubular element 120 preferably has a denier per filament of greater than 3. This denier per filament has been found to allow the formation of a tubular element 120 which is not too dense. Preferably, the denier per filament is at least 4, more preferably at least 5. In preferred embodiments, the filamentary tow forming the hollow tubular element 120 has a denier per filament between 4 and 10, more preferably between 4 and 9. In one example, the filamentary tow forming the hollow tubular element 120 has an 7.3Y36,000 tow formed from cellulose acetate and comprising 18% plasticiser, for instance triacetin.

The hollow tubular element 120 preferably has an internal diameter of greater than 3.0 mm. Smaller diameters than this can result in increasing the velocity of aerosol passing though the mouthpiece 2 to the consumers mouth more than is desirable, such that the aerosol becomes too warm, for instance reaching temperatures greater than 40° C. or greater than 45° C. More preferably, the hollow tubular element 120 has an internal diameter of greater than 3.1 mm, and still more preferably greater than 3.5 mm or 3.6 mm. In one embodiment, the internal diameter of the hollow tubular element 120 is about 4.7 mm.

The hollow tubular element 120 preferably comprises from 15% to 22% by weight of plasticiser. For cellulose acetate tow, the plasticiser is preferably triacetin, although other plasticisers such as polyethelyne glycol (PEG) can be used. More preferably, the hollow tubular element 120 comprises from 16% to 20% by weight of plasticiser, for instance about 17%, about 18% or about 19% plasticiser.

In the present example, the first hollow tubular element 120, body of material 110 and cooling section 100 are combined using a second plug wrap 140 which is wrapped around all three sections. Preferably, the second plug wrap 140 has a basis weight of less than 50 gsm, more preferably between about 20 gsm and 45 gsm. Preferably, the second plug wrap 140 has a thickness of between 30 μm and 60 μm, more preferably between 35 μm and 45 μm. The second plug wrap 140 is preferably a non-porous plug wrap having a permeability of less than 100 Coresta Units, for instance less than 50 Coresta Units. However, in alternative embodiments, the second plug wrap 140 can be a porous plug wrap, for instance having a permeability of greater than 200 Coresta Units.

In the present example, the article 1 has an outer circumference of about 23 mm. In other examples, the article can be provided in any of the formats described herein, for instance having an outer circumference of between 20 mm and 26 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 20 mm and 24 mm, and more preferably between 20 mm and 23 mm, have been found to provide a good balance between providing effective aerosol delivery while allowing for efficient heating.

A tipping paper 150 is wrapped around the full length of the mouthpiece 2 and over part of the rod of aerosol-generating material 3 and has an adhesive on its inner surface to connect the mouthpiece 2 and rod 3. In the present example, the rod of aerosol-generating material 3 is wrapped in wrapper 90, which forms a first wrapping material, and the tipping paper 150 forms an outer wrapping material which extends at least partially over the rod of aerosol-generating material 3 to connect the mouthpiece 2 and rod 3. In some examples, the tipping paper can extend only partially over the rod of aerosol-generating material.

In the present example, the tipping paper 150 extends 5 mm over the rod of aerosol-generating material 3 but it can alternatively extend between 3 mm and 10 mm over the rod 3, or more preferably between 4 mm and 6 mm, to provide a secure attachment between the mouthpiece 2 and rod 3. The tipping paper can have a basis weight greater than 20 gsm, for instance greater than 25 gsm, or preferably greater than 30 gsm, for example 37 gsm. These ranges of basis weights have been found to result in tipping papers having acceptable tensile strength while being flexible enough to wrap around the article 1 and adhere to itself along a longitudinal lap seam on the paper. The outer circumference of the tipping paper 150, once wrapped around the mouthpiece 2, is about 23 mm.

The article has a ventilation level of about 10% of the aerosol drawn through the article. In alternative embodiments, the article can have a ventilation level of between 1% and 20% of aerosol drawn through the article, for instance between 1% and 12%. Ventilation at these levels helps to increase the consistency of the aerosol inhaled by the user at the mouth end 2b, while assisting the aerosol cooling process. The ventilation is provided directly into the mouthpiece 2 of the article 1. In the present example, the ventilation is provided into the cooling section 100 which has been found to be particularly beneficial in assisting with the aerosol generation process. The ventilation is provided via perforations 160, in the present case formed as a single row of laser perforations, positioned 13 mm from the downstream, mouth-end 2b of the mouthpiece 2. In alternative embodiments, two or more rows of ventilation perforations may be provided. These perforations pass though the tipping paper 150, second plug wrap 140 and cooling section 100. In alternative embodiments, the ventilation can be provided into the mouthpiece at other locations, for instance into the body of material 110 or first tubular element 120. Preferably, the article is configured such that the perforations are provided about 28 mm or less from the upstream end of the article 1, preferably between 20 mm and 28 mm from the upstream end of the article 1. In the present example, the apertures are provided about 25 mm from the upstream end of the article.

The article 1 is suitable for use with a non-combustible aerosol provision device.

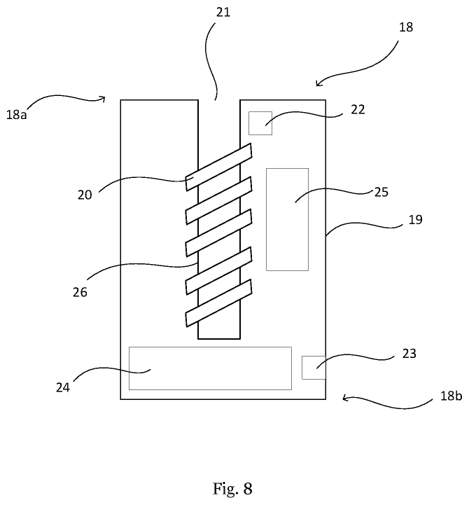

FIG. 8 shows an example of a non-combustible aerosol provision device 18 having a proximal end 18a and a distal end 18b.

In broad outline, the device 18 may be used to cause an article as described herein comprising an aerosol-generating composition comprising a fibrous susceptor and aerosol generating material, to generate an aerosol which is inhaled by a user of the device 18. The device 18 and the article (not shown) together form a system.

The device 18 comprises a magnetic field generator comprising a coil 20 configured to generate varying magnetic field. The varying magnetic field causes a susceptor in the article to generate heat which, in turn, heats the generating aerosol to form an aerosol.

The device 18 comprises a housing 19 which surrounds and houses various components of the device 18. The device 18 has an opening 21 in one end, through which the article may be inserted. In use, the article may be fully or partially inserted into the heating assembly.

The device 18 may also include a user-operable control element 22, such as a button or switch, which operates the device 18 when pressed. For example, a user may turn on the device 18 by operating the switch 22.

The device 18 may also comprise an electrical component, such as a socket/port 23, which can receive a cable to charge a power source 24 of the device 18. For example, the socket 23 may be a charging port, such as a USB charging port.

In use, a user inserts an article into the opening 21, operates the user control 22 to begin heating the aerosol generating material and draws on the aerosol generated in the device. This causes the aerosol to flow through the device 18 along a flow path towards the proximal end 18a of the device 18.

The other end of the device furthest away from the opening 21 may be known as the distal end 18b of the device 18 because, in use, it is the end furthest away from the mouth of the user. As a user draws on the aerosol generated in the device, the aerosol flows away from the distal end of the device 18.

The power source 24 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the magnetic field generator to supply electrical power when required and under control of a controller (not shown) to heat the aerosol generating material.

The device further comprises at least one electronics module 25. The electronics module 25 may comprise, for example, a printed circuit board (PCB). The PCB 25 may support at least one controller, such as a processor, and memory. The PCB 25 may also comprise one or more electrical tracks to electrically connect together various electronic components of the device 18. For example, battery terminals (not shown) may be electrically connected to the PCB 25 so that power can be distributed throughout the device 18. The socket 23 may also be electrically coupled to the battery via the electrical tracks.

The device 18 includes a magnetic field generator comprising a coil 20 that is configured to inductively heat a susceptor in the article.

The coil 20 is an inductor coil. The inductor coil is made from an electrically conducting material. In this example, the inductor coil is made from Litz wire/cable which is wound in a helical fashion to provide a helical inductor coil. Litz wire comprises a plurality of individual wires which are individually insulated and are twisted together to form a single wire. Litz wires are designed to reduce the skin effect losses in a conductor. In the example device 18, the inductor coil is made copper and the Litz wire has a rectangular cross section. In other examples the Litz wire can have other shape cross sections, such as circular.

The inductor coil 20 is configured to generate a first varying magnetic field for heating a susceptor an article. The inductor coil 20 can be connected to the PCB 25.

The device comprises inductor coil support tube 26. The coil support tube 26 is defined by an outer surface an inner surface. The outer surface of the coil support tube supports the inductor coil of the magnetic field generator 20. The inner surface defines a cavity into which the article can be inserted. Tube 26 is preferably made from a material that is not heatable by penetration with a varying magnetic field. This is to avoid the inductor heating the tube during use and also to reduce power consumption.

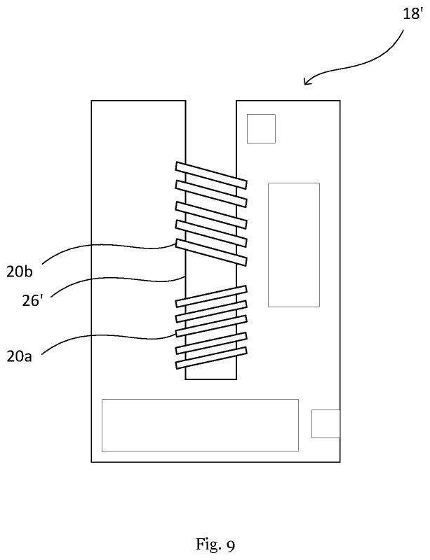

Referring to FIG. 9, the device 18′ comprises two magnetic field generators comprises a first inductor coil 20a and a second inductor coil 20b. The first inductor coil 20a is configured to generate a first varying magnetic field for heating a susceptor in the article 1 and the second inductor coil 20b is configured to generate a second varying magnetic field for heating a second susceptor. In this example, the first inductor coil 20a is adjacent to the second inductor coil 20b in a direction along the longitudinal axis of the device 18′ (that is, the first and second inductor coils 20a, 20b to not overlap). The first and second inductor coils 20a, 20b can be connected to the PCB. The first and second coils are supported by the coil support tube 26′.

It will be appreciated that the first and second inductor coils 20a, 20b, in some examples, may have at least one characteristic different from each other. For example, the first inductor coil 20a may have at least one characteristic different from the second inductor coil 20b. More specifically, in one example, the first inductor coil 20a may have a different value of inductance than the second inductor coil 20b. The first and second inductor coils 20a, 20b can be of different lengths. Thus, the first inductor coil 20a may comprise a different number of turns than the second inductor coil 20b (assuming that the spacing between individual turns is substantially the same). In yet another example, the first inductor coil 20a may be made from a different material to the second inductor coil 20b. In some examples, the first and second inductor coils 20a, 20b may be substantially identical.

In this example, the first inductor coil 20a and the second inductor coil 20b are wound in opposite directions. This can be useful when the inductor coils are active at different times. For example, initially, the first inductor coil 20a may be operating to heat a first section/portion of the article, and at a later time, the second inductor coil 20b may be operating to heat a second section/portion of the article. Winding the coils in opposite directions helps reduce the current induced in the inactive coil when used in conjunction with a particular type of control circuit. In FIG. 9, the first inductor coil 20a is a right-hand helix and the second inductor coil 20b is a left-hand helix. However, in another embodiment, the inductor coils 20a, 20b may be wound in the same direction, or the first inductor coil 20a may be a left-hand helix and the second inductor coil 20b may be a right-hand helix.

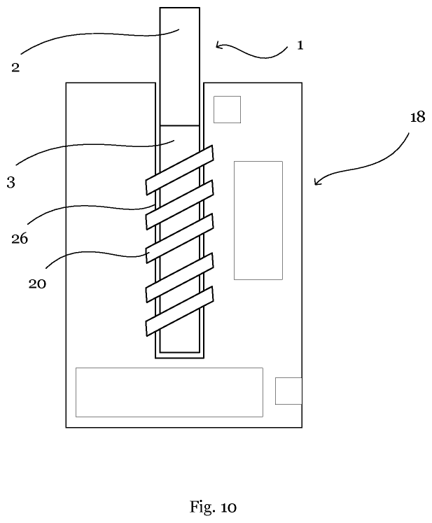

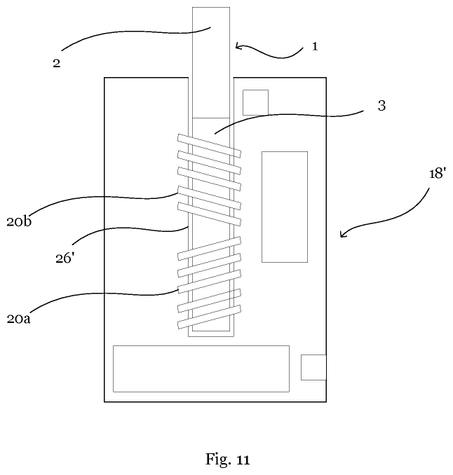

In use, the article 1 described herein can be inserted into a non-combustible aerosol provision device such as the device 18 and 18′ described with reference to FIGS. 10 and 11. At least a portion of a mouthpiece 2 of the article 1 protrudes from the non-combustible aerosol provision device 18, 18′ and can be placed into a user's mouth. An aerosol is produced by heating the aerosol generating section 3 comprising aerosol-generating material and a susceptor at least partially embedded in the aerosol-generating material using the device 18, 18′. The aerosol produced by the aerosol generating material passes through the mouthpiece 2 to the user's mouth.

Referring to FIG. 10, the magnetic field generator comprises a single coil 20. The magnetic field generator is configured to inductively heat the susceptor in the aerosol-generating section 3 by generation of a varying magnetic field.

The outer surface of the article 1 may be dimensioned so that the outer surface of the article 1 abuts the inner surface of the coil support tube 26. This ensures that the heating is most efficient because the aerosol-generating section is closer to the coil 20.

FIG. 11 shows an article 1 as described herein received within the coil support tube 26′ of the device 18′. The magnetic field generator comprises two coils 20a and 20b. This enables different portions of the aerosol-generating section 3 to be heated at different times and/or to different temperatures by controlling the activation of the coils 20a, 20b.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol-generating composition comprising an aerosol-generating material and a fibrous susceptor material.

2. An aerosol-generating composition as claimed in claim 1, wherein the fibrous susceptor material is permeable to the passage of gas.

3. An aerosol-generating composition as claimed in claim 1, wherein the fibrous susceptor material is a woven or non-woven material.

4. An aerosol-generating composition as claimed in claim 1, wherein the fibrous susceptor material comprises metal fibres or carbon fibres.

5. An aerosol-generating composition as claimed in claim 1, wherein the fibrous susceptor material is in the form of a sheet or shredded sheet.

6. An aerosol-generating composition as claimed in claim 5, wherein the sheet has a thickness of 150 μm to 300 μm.

7. An aerosol-generating composition as claimed in claim 1, wherein the aerosol-generating material comprises:
binder;
aerosol-former;
optionally an active or flavour; and
optionally a filler.

8. An aerosol-generating composition as claimed in claim 1, wherein the aerosol-generating material comprises botanical material.

9. An aerosol-generating composition as claimed in claim 1, wherein the aerosol-generating composition comprises a plurality of strands of aerosol-generating material.

10. An aerosol-generating composition as claimed in claim 1, wherein the article comprises a plurality of strands of the fibrous susceptor material.

11. An aerosol-generating composition as claimed in claim 9, wherein the strands of aerosol-generating are substantially parallel to one another.

12. An aerosol-generating composition as claimed in claim 10, wherein the strands of fibrous susceptor material are substantially parallel to one another.

13. An aerosol-generating composition as claimed in claim 11, wherein the strands of aerosol-generating material and the strands of fibrous susceptor material are substantially parallel to one another.

14. An aerosol-generating composition as claimed in claim 9, wherein each of the strands of aerosol-generating material is substantially straight.

15. An aerosol-generating composition as claimed in claim 10, wherein each of the strands of fibrous susceptor material are substantially straight.

16. An aerosol-generating composition as claimed in claim 10, wherein the strands of fibrous susceptor material have a length of 10 mm to 15 mm.

17. An aerosol-generating composition as claimed in claim 1, wherein the aerosol-generating composition comprises reconstituted tobacco material.

18. An aerosol-generating composition as claimed in claim 1, wherein the fibrous susceptor material comprises fibres that are randomly oriented with respect to each other.

19. A process for manufacturing an aerosol-generating composition as claimed in claim 1, wherein the process comprises combining the aerosol-generating material with the fibrous susceptor material.

20. A process as claimed in claim 19, wherein the process comprises:
providing a sheet of the aerosol-generating material;
providing a sheet of the fibrous susceptor material;
cutting the sheet of aerosol-generating material to form a plurality of discrete portions of aerosol-generating material;
cutting the sheet of fibrous susceptor material to form a plurality of discrete portions of fibrous susceptor material; and
combining the plurality of discrete portions of aerosol-generating material with the plurality of discrete portions of fibrous susceptor material to form the aerosol-generating composition.

21. A process as claimed in claim 20, wherein the sheet of aerosol-generating material and the sheet of fibrous susceptor material are cut simultaneously.

22. An aerosol-generating composition manufactured according to the process of claim 19.

23. A component for an article for an article for use with a non-combustible aerosol provision device, the component comprising a composition as claimed in claim 1.

24. A component as claimed in claim 23, wherein the component comprises a wrapper circumscribing the aerosol-generating composition.

25. A component as claimed in claim 24, wherein the component is in the form of a rod.

26. A component as claimed in claim 23, wherein the component is an aerosol-generating section for an article for use with a non-combustible aerosol provision device.

27. A process for manufacturing a component as claimed in claim 23, the process comprising:
inserting one or more of a plurality of discrete portions of aerosol-generating material into a wrapper; and
inserting one or more of a plurality of discrete portions of fibrous susceptor material into the wrapper to form the component.

28. A process for manufacturing a component as claimed in claim 23, the process comprising:
combining an aerosol-generating composition with a fibrous susceptor material field to form a mixture; and
circumscribing the mixture with a wrapper to form the component.

29. A process as claimed in claim 27, wherein the process comprises gathering the strands together to form a rod.

30. A process as claimed in claim 27, wherein the process comprises cutting a sheet of aerosol-generating composition longitudinally to produce the plurality of discrete portions of aerosol-generating material and cutting the sheet of fibrous susceptor material longitudinally to produce the plurality of discrete portions of fibrous susceptor material.

31. A component for an article for use with a non-combustible aerosol provision device manufactured according to the process as claimed in claim 26.

32. A component as claimed in claim 23, wherein the component is an aerosol-generating section of an article for use with a non-combustible aerosol-provision device.

33. An article for use with a non-combustible aerosol-provision device comprising the component as claimed in claim 32.
